(19) United States
(12) Patent Application Publication
(10) Pub. No.: US 2004/0175563 A1
(43) Pub. Date: Sep. 9, 2004

(54) Thick thermoplastic composites

(76) Inventor: C. Albert Okerson, Franklin, TN (US)

Correspondence Address: Richard S. Myers, Jr., Stites & Harbison PLLC, Suite 1800, 424 Church Street, Nashville, TN, 37219-2376, US

(21) Appl. No.: 10/792,724

(22) Filed: Mar. 5, 2004

Related U.S. Application Data
(60) Provisional application No. 60/452,299, filed on Mar. 5, 2003.

(51) Int. Cl. B32B 5/16

(52) U.S. Cl. 428/331; 428/500

(57) ABSTRACT

A thick thermoplastic composite extrusion such as a railroad crosstie, marine piling, timber (such as a bridge timber), utility pole, highway guardrail, highway guardrail post, residential or marine decking material, fence post, fence rail, or house siding which is fabricated from a mineral filled thermoplastic composition.

### PRIORITY INFORMATION

This application claims priority under 35 U.S.C. § 119(e) of provisional patent application No. 60/452,299, filed on Mar. 5, 2003, the contents of which are incorporated herein by reference in their entirety.

### FIELD OF THE INVENTION

The present invention relates to the field of thermoplastic extrusions that are filled with talc or a talc blend.

### BACKGROUND OF THE INVENTION

The use of polymeric materials and composites has steadily increased in recent years because of many beneficial properties. For example, the use of plastic or polymeric materials is the combination of light weight and high strength. Furthermore, polymeric materials do not readily biodegrade.

In a preferred embodiment of the present invention, the inventive composites disclosed herein can be particularly beneficial when replacing wood. As stated in U.S. Pat. No. 5,886,078, incorporated herein by reference, wood based railroad ties are particularly susceptible to wear and deterioration due to processes such as erosion caused by weather such as freezing cycles, insect attack, and water penetration. The composites of the present invention overcome all the above concerns. U.S. Pat. No. 5,886,078 discloses polymeric composites that comprise a polymer component that comprises polyolefins preferably obtained as waste or recycle, and a reinforcing filler comprising primarily mica. However, the composites of the '078 patent have a significantly high number of voids such that at least portions of the composite core is described as being foamed. Such voids would be detrimental to the life span of a composite that must support weight, especially tremendous amounts of weight such as the weight produced over a railroad tie.

In addition to U.S. Pat. No. '078, there have been other attempts to create a thermoplastic tie that is capable of withstanding the extreme load of railroad ties. For example, U.S. Pat. No. 5,055,350 discloses making railroad crossties from sand and recycled thermoplastic containers by coating the sand with an adhesive substance. However, the use of sand can result in various problems or disadvantages in connection with the process including problems with excessive weight and excessive abrasiveness when used in the extrusion process.

Other prior polymeric compositions include those disclosed in U.S. Pat. No. 4,528,303, which discloses a molding composition that comprises a polymeric matrix, an inorganic filler material, and, advantageous polymer/filler coupling agent. The compositions of '303 are generally in the form of rods, which are then chopped into granules or pellets. These granules will subsequently be used to form the desired ultimate shaped articles in conventional injection-molding, transfer-molding or extrusion-molding apparatuses.

Contrary to the method of U.S. Pat. No. '303, the present invention provides a polymer composition that is suitable for producing large composites. The composition is extruded directly into the final product rather that going through a first step—such as pellet formation. It is a one-step extrusion process through compound extruder that produces a large composite and/or an elongated product. There is no need for a pre-pelletization process.

U.S. Pat. No. 6,403,692 discloses a filled thermoplastic composition in extruded or molded articles that is prepared by admixing a thermoplastic polymer, an uncalcined filler, and a calcined filler. The calcination treatment describe herein consists of heating the selected mineral to a temperature of at least 800° C.

### OBJECTS AND SUMMARY OF THE INVENTION

An object of the present invention is to provide an elongated thermoplastic composite that is stiff and high in flex strength, and suitable for being used in the place of wood.

Another object of the present invention is to provide a replacement for wood, such as a railroad crosstie, decking lumber, etc. that is not as susceptible to insect attack and not as susceptible to erosion.

Another object of the present invention is to provide an elongate composite of core/sheath structure that is stiff and high in flex strength, and suitable for being used in the place of wood. This composite comprises a solid core and a solid sheath that is substantially free from voids throughout the core and sheath. Furthermore, the voids that are present are uniformly dispersed.

Another object of the present invention is a method of making an inventive composite of the present invention that can be produced by using a composition that is suitable for producing large composites. This composition is extruded directly into the final product rather than going through a pre-extrusion pelletization step.

Another embodiment of the present invention is to provide an elongate composite that has sufficient strength and stiffness that additional materials such as re-bar-type reinforcement rods are not required.

Another embodiment of the present invention is to provide an elongate composite that has sufficient strength and stiffness that substantial quantities of phosophogypsum are not required.

Finally, another object of the present invention is to provide a thermoplastic composition that is suitable for producing composites of the present invention.

With respect to the present invention, an elongated composite is generally one that is at least about three feet in length.

One embodiment of the present invention is an elongated thermoplastic composite extrusion comprised of (a) about 30% to about 65% of a thermoplastic resin; and (b) about 30% to about 60% by weight of a talc or talc blend filler.

Another embodiment of the present invention is a large, elongated polymeric composite that comprises a central longitudinal axis and consists essentially of about 35% to about 65% by weight of a thermoplastic resin, and about 25% to about 45% by weight of talc.

Another embodiment of the present invention is a large, elongated polymeric composite that comprises a central longitudinal axis; a solid core that has a peripheral surface and extends a length of the axis, and a solid sheath that surrounds and bonds with a length of the peripheral surface of the core. The core and the sheath independently of one another may consist essentially of about 35% to about 65% by weight of a thermoplastic resin, and about 25% to about 45% by weight of talc. In this embodiment, the core and sheath are substantially free of voids; and the elongated polymeric composite is at least about 3 feet in length and at least about 0.5 inches in diameter from the central longitudinal axis to an outer surface of the sheath.

Another embodiment of the present invention is a thermoplastic composite that comprises about 35% to about 65% of a thermoplastic resin selected from the group consisting of low-density polyethylene, high-density polyethylene, linear polyethylene, polypropylene, and blends thereof and (b) about 40% to about 60% by weight of a talc blend. In this embodiment, the elongated composite at least about 3 feet in length.

Another embodiment of the present invention is a thermoplastic composite that comprises a core element that comprises (a) about 35% to about 65% of a thermoplastic resin selected from the group consisting of low-density polyethylene, high-density polyethylene, linear polyethylene, polypropylene, and blends thereof and (b) about 40% to about 60% by weight of a talc blend; and a sheath element that is bonded to the core element and independently of the core comprises (a) about 35% to about 65% of a thermoplastic resin selected from the group consisting of low-density polyethylene, high-density polyethylene, linear polyethylene, polypropylene, and blends thereof and (b) about 40% to about 60% by weight of a talc blend. In this embodiment, the core and sheath are substantially free from shrinkage voids; and the core and sheath together form an elongated composite at least about 3 feet in length.

Yet another embodiment of the present invention is a thermoplastic composition that consists essentially of a reclaimed thermoplastic resin in an amount from about 35% to about 65% (by weight) selected from the group consisting of low-density polyethylene, high-density polyethylene, linear polyethylene, polypropylene, and blends thereof; talc particles in at least about 25% to about 45% by weight of the composition; and a mineral filler additives in an amount of from about 15% to about 40% by weight of the composition selected from the group consisting of pigments, dyes, antioxidants, ultraviolet light stabilizers, slip agents, nucleating agents, anti-fungal agents, mold releases, and combinations thereof.

The thermoplastic resin that can be used in the present invention is not specifically limited. Preferably, the thermoplastic resin is a polyolefin, preferably selected from the group consisting of low-density polyethylene, high-density polyethylene, linear polyethylene, polypropylene, and blends thereof. More preferably, the thermoplastic resin is a reclaimed thermoplastic resin. An advantage of the present invention is that recycled or reclaimed polymers may be used. Furthermore, in all embodiments discloses herein, the core material is optionally a different material than the sheath material.

### BRIEF DESCRIPTION OF THE DRAWINGS

The following drawings depict preferred examples of the present invention. These drawings/examples are given for illustration of embodiments of the present invention, and are not intended to be limiting thereof.

FIG. 1 is a cross sectional illustration of a composite railroad crosstie which is manufactured without the aid of the present invention and according to prior art processes. As is shown in the drawing, such composites have excessive internal voids.

FIG. 2 is a cross sectional illustration of a composite railroad tie of the present invention manufactured via sequential extrusion or conventional flow molding. This composite has a typically acceptable uniform void distribution. The sizes of the voids depicted in this figure are for illustrative purposes only. In normal practice, voids may be of such small size they would prove to be difficult to detect and very difficult to depict on a drawing.

FIG. 3 is a cross sectional illustration of a composite railroad tie of the present invention manufactured via continuous sequential extrusion with a shell/core arrangement. This composite has a typically acceptable uniform void distribution. The sizes of the voids depicted in this figure are for illustrative purposes only. In normal practice, voids may be of such small size they would prove to be difficult to detect and very difficult to depict on a drawing.

FIG. 4 is a cross sectional illustration of a composite marine piling of the present invention which is manufactured via continuous sequential extrusion. The sizes of the voids depicted in this figure are for illustrative purposes only. As stated above, in normal practice, voids may be of such small size they would prove to be difficult to detect and very difficult to depict on a drawing.

### DESCRIPTION OF THE INVENTION

As stated above, an embodiment of the present invention is an elongated thermoplastic composite extrusion, comprised of: (a) about 30% to about 65% of a reclaimed thermoplastic resin selected from the group consisting of low-density polyethylene, high-density polyethylene, linear polyethylene, polypropylene, and blends thereof; and (b) about 30% to about 60% by weight of a talc or talc blend filler.

The inventor has discovered that with the addition of talc or the talc blend of the present invention, the thick thermoplastic extrusions of the present invention demonstrate an increase in flexural modulus (which is a measure of stiffness) and a decrease in the coefficient of thermal expansion. Stiffness and low coefficient of thermal expansion are preferred characteristics for railroad crossties and other composites of the present invention. Furthermore, and without being bound by theory, the addition of the talc or the talc blend of the present invention acts as a nucleating agent for formation of bubbles in the matrix. That is, the addition of the talc or talc blend helps reduce or eliminate shrinkage voids. Additionally, the addition of the talc or talc blend allows the composites of the present invention to have an increased heat distortion temperature.

In other embodiments of the present invention, the composites of the present invention have a core/sheath arrangement. The core is formed about a central axis of the composite, and the sheath is formed around the core. In embodiments of the present invention, the core may be round. In other embodiments, the core may be designed with configurations that minimize the surface area to increase heat transfer during the production of the sheath element. Also, the core may be manufactured that may facilitate mechanical attachment between the layers of the finished product. The only real limitation to the shape of the core or inner layer is dependent on the ability of a subsequent crosshead extrusion die. Typically, in these embodiments, the core is present in any amount of from about 10% to about 70% by weight of the final composite. In other embodiments, the core is present from about 40% to about 60%.

The polymeric material that comprises the shell may or may not be the same polymeric material that comprises the core. Furthermore, each profile may have a different ratio of talc, fillers, and modifiers.

As stated above, the thermoplastic resin that can be used with the present invention is not specifically limited. As one of ordinary skill in the art would understand, in embodiments where recycled or reclaimed polymers are used, the makeup of the resin would greatly vary. Also, it is understood that all the groups of ingredients herein include optional blends of at least two of the components listed.

As an example of a resin that of the present invention, the thermoplastic resin disclosed in U.S. Pat. No. 5,013,773, incorporated herein by reference, may be used. That is, the thermoplastic resin may include, for example, polyolefins, polyvinyl chloride, polystyrene, acrylic resin, ABS resin, nylon, polycarbonate, and thermoplastic polyester. These thermoplastic resins may be homopolymers, copolymers, or mixtures of two or more thermoplastic resins. Polyolefins are preferable among the above-mentioned thermoplastic resins.

Examples of the polyolefins include polyethylene (such as high-density polyethylene, medium-density polyethylene, low-density polyethylene, and linear low-density polyethylene), polypropylene, and polybutene. All of the above polymers may be used individually or in combination with one another.

In a preferred embodiment, the thermoplastic composition may comprise polyolefin polymers. The polyolefin polymers of this embodiment specifically include polymers of monoolefins and diolefins, for example polypropylene, polyisobutylene, polybutene-1, polymethylpentene-1, polyisoprene or polybutadiene, as well as polymers of cycloolefins, for instance of cyclopentene or norbornene, polyethylene, for example high density polyethylene, low density polyethylene and linear low density polyethylene may be used. Mixtures of these polymers, for example mixtures of polypropylene with polyethylene and mixtures of different types of polyethylene, may also be used. Also useful are copolymers of monoolefins and diolefins with each other or with other vinyl monomers, such as, for example, ethylene/propylene, linear low density polyethylene and its mixtures with low density polyethylene, propylene/butene-1, ethylene/hexene, ethylene/ethylpentene, ethylene/heptene, ethylene/octene, propylene/isobutylene, ethylene/butane-1, propylene/butadiene, isobutylene/isoprene, ethylene/alkylacrylates, ethylene/alkyl methacrylates, ethylene/vinyl acetate or ethylene/acrylic acid copolymers and salts thereof and terpolymers of ethylene with propylene and a diene, such as hexadiene, dicyclopentadiene or ethylidene-norbornene, as well as mixtures of such copolymers and their mixtures with polymers mentioned above, or example polypropylene/ethylene-propylene-copolymers, low density polyethylene/ethylene vinyl acetate. Also suitable are polyvinyl chlorides.

Preferably, the thermoplastic resin selected from the group consisting of low-density polyethylene, high-density polyethylene, linear polyethylene, polypropylene, and blends thereof.

Additionally, examples of polyolefin polymers that can be used in connection with the compositions and composites of the present invention include those from U.S. Pat. No. 5,799,870. Thus, the polyolefin polymers of this embodiment include monoolefins and diolefins, for example polypropylene, polyisobutylene, polybutene-1, polymethylpentene-1, polyisoprene or polybutadiene, as well as polymers of cycloolefins, for instance of cyclopentene or norbornene, polyethylene, for example high density polyethylene, low density polyethylene and linear low density polyethylene may be used. Mixtures of these polymers, for example mixtures of polypropylene with polyethylene and mixtures of different types of polyethylene, may also be used. Also useful are copolymers of monoolefins and diolefins with each other or with other vinyl monomers, such as, for example, ethylene/propylene, linear low density polyethylene and its mixtures with low density polyethylene, propylene/butene-1, ethylene/hexene, ethylene/ethylpentene, ethylene/heptene, ethylene/octene, propylene/isobutylene, ethylene/butane-1, propylene/butadiene, isobutylene/isoprene, ethylene/alkylacrylates, ethylene/alkyl methacrylates, ethylene/vinyl acetate or ethylene/acrylic acid copolymers and salts thereof and terpolymers of ethylene with propylene and a diene, such as hexadiene, dicyclopentadiene or ethylidene-norbornene, as well as mixtures of such copolymers and their mixtures with polymers mentioned above, or example polypropylene/ethylene-propylene-copolymers, low density polyethylene/ethylene vinyl acetate. Also suitable are polyvinyl chlorides.

While virgin resins perform well in connection with the present invention, the thermoplastic resin is preferably recycled, reclaimed, or “waste” thermoplastic resin. Polymeric materials are additionally not readily biodegradable. This long lifespan is however also one of the more negative aspects incumbent with the use of polymers. The fact that very large proportion of polymers and in particular polyolefins is used in disposable or short-lived applications necessitates that a considerable amount of waste polymer is generated shortly after it is produced. A more effective long term solution to the growing volume of waste polymer, particularly polyolefins, would be to utilize the waste plastic as a component in construction materials that require a relatively long lifespan.

Reclaimed thermoplastic resins specifically include those resins reclaimed from the post consumer waste stream. Bottles, jugs, and other thermoplastic containers which have been discarded by the consumer are reclaimed from municipal waste before disposal in landfills. After collection, the thermoplastic waste is shredded and ground to reduce the thermoplastic particle size to useable particles. This particle size is usually flakes of less than 0.5 inch×0.5 inch× the original wall thickness of the container. These flakes are then washed, dried, stripped and conveyed into a bin feeding the compounded extruder.

Impurities from thermoplastic containers may be residues of the materials originally in the container, metal contaminates from metal containers or metal lids, and product labels which were adhered to the original containers. Most of these contaminates are removed during the washing, drying and stripping process. Many contaminant particles are not deemed a problem in thick composite products. Additionally, the reclaimed resin of the present invention may be unfiltered reclaimed resin.

The recycled thermoplastic resin of the present invention may be the “waste polyolefins” described in U.S. Pat. No. 5,886,708, incorporated herein by reference.

The thermoplastic resin is present in an amount of any percentage from about 35% to about 65% by weight of the composite. The talc of the present invention may be present in an amount of from about 25% to about 45%. The mineral filler (i.e., “filler”) of the present invention may be present in an amount from about 15% to about 40%. The talc and mineral filler can be combined to form a “talc blend.”

The talc of the present invention may be any commercially available talc. Talc is preferably a hydrous silicate mineral composed of magnesium (Mg), silicon and oxygen (SiO₂, silica), and water. The chemical formula of this preferred embodiment is Mg₃Si₄O₁₀(OH)₂. The talc of the present invention is preferably relatively pure, but can contain small amounts of aluminum, iron, manganese, titanium, and other impurities. The talc of the present invention can appear white, apple green, dark green, or brown, depending on its composition.

An example of the talc of the present invention is Vertal UA40 available from Luzenac America, Inc. This material is a naturally occurring blend of talc and magnesium carbonate.

Without being bound by theory, the addition of the talc in the composites of the present invention is believed to help prevent the existence of shrinkage voids. Voids are formed by shrinkage and entrapment of volatile, such as water vapor or organic contaminants during the cooling step following extrusion or molding. The talc particles help keep the voids small and well dispersed throughout the matrix of the composite. Reduction of voids and dispersion of voids is advantageous in that it results in an increase of strength, particularly load-bearing strength.

In a preferred embodiment, voids are present in the composite in an amount of less than about 5% of the area of the composite, preferably in an amount of less than about 3%, and more preferably less than an amount less than about 1%.

In a preferred embodiment, the thermoplastic composite extrusion of the present invention has a reclaimed thermoplastic resin content of from about 30% to about 70% by weight. When the resin content is less than about 30%, the composition is poor in impact resistance, nail or rail spike penetration, and surface properties. When the resin content is greater than about 65%, the composite becomes poorer in stiffness, undesirable in some uses of the composite.

The talc blend of the present invention may comprise talc and at least one filler selected from the group consisting of calcium carbonate, mica, marble dust, graphite, aluminum flake, diatomaceous earth, cement dust, clay, feldspar, silica, glass, fumed silica, silicates, alumina, magnesium oxide, antimony oxide, zinc oxide, barium sulfate, aluminum silicate, calcium silicate, titanium oxides, glass micro spheres, wollastonite, nephelene syenite, calcium sulfate, gypsum, chalk, carbon black, and blends thereof. In embodiments of the present invention where a talc blend is used, the filler (mineral filler) content is about 15% by weight to about 40% by weight. In other embodiments, the total filler is present in a range of from about 40% to about 60%. The talc blend content may range from about 30%-40% (by weight), and in other embodiments about 40%-60% (by weight).

The talc and talc blend should have a particle size of from about 0.3 μm to about 10 μm.

The composites of the present invention may further, optionally comprise flame retardants such as halogenated materials, preferably chlorinated or brominated compounds. The filler of the present invention is of a nature containing phosphates which provides the potential additional advantage of added flame retardency in the composition. Suitable flame proofing additives include low molecular weight bromine compounds, and examples include octabromodiphenyl ethers, tetrabromophthalimide, tribromophenoxymehtane, bis(tribromophenoxy)ethane, poly or oligomeric tetrabromobisphenol A, tris (tribromophenyl) triphosphate, trichlorotetrabromotoluene, hexabromocyclododecane and decabromodiphenyl ether.

Compatibilizers may optionally be used to help effectuate the mixing (i.e., compatibility) of two or more polymers which might comprise the source of polymer used in the composite. These compatibilizers will typically have reactive groups that upon heating and shearing will react with the polymers via free radical or ionic mechanisms. Compatibilizers which have been employed include the various maleic anhydride copolymers and ionomers, acrylate copolymers, and ethylene acrylic acid copolymers.

Finally, the composites of the present invention may incorporate other additives such as pigments, dyes, and antioxidants, ultraviolet light stabilizers, slip agents, nucleating agents, anti-fungal agents, mold releases, etc., and combinations thereof. The additives may be present in amounts ranging from about 0.1% (weight) to about 5%.

The resulting composites have many uses, as would be understood by one of ordinary skill in the art. For example, preferred embodiments of the composites of the present invention are railroad cross ties. In this embodiment, the composites at least meet the American Railway Engineers Maintenance—Way Association specifications.

Suitable railroad ties may for example have lengths of from 6 feet to 25 feet and widths of from 8 inches to 12 inches and heights of from 5 inches to 10 inches. The weight of the railroad tie may range from about 200 to about 900 pounds depending on the size and the length of the tie.

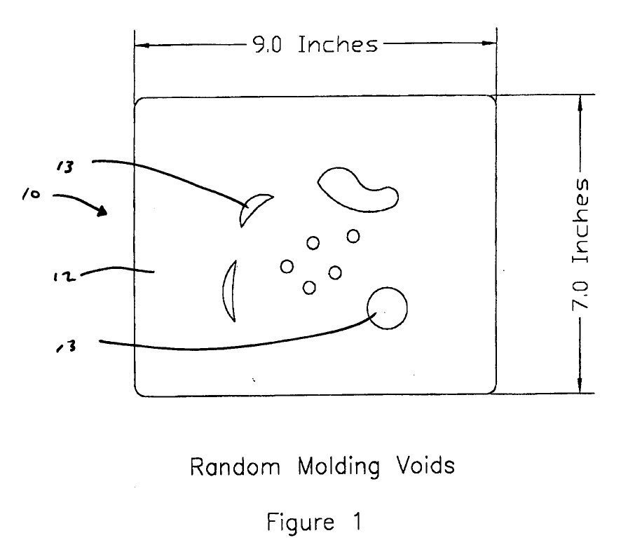

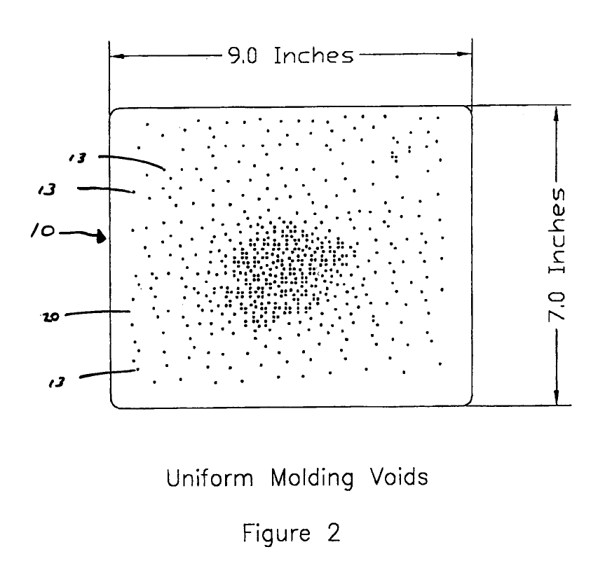

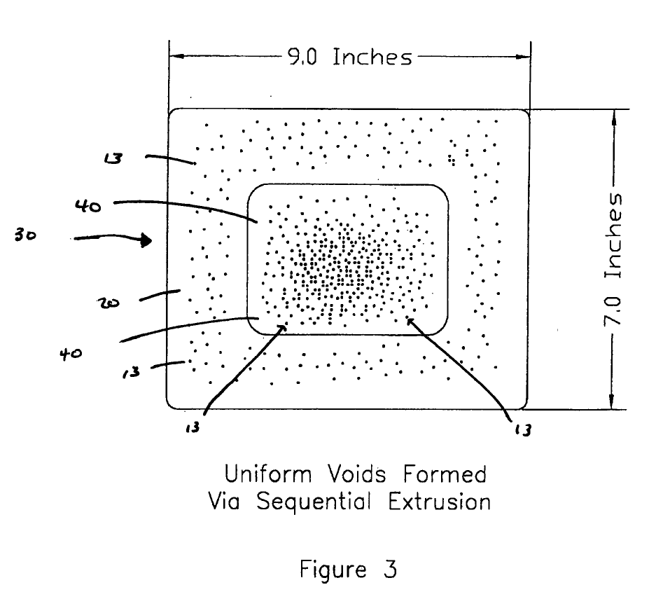

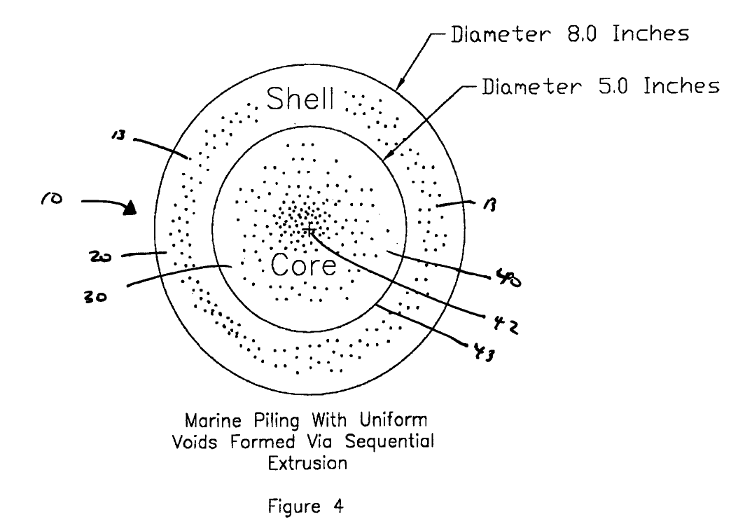

Examples of railroad ties, or railroad-type components of the present invention are depicted in the drawings, which show cross sections of various composites. FIG. 1 shows an elongated composite 10 comprises of a thermoplastic material 12. This composite has developed random shrinkage voids 13. The voids greatly impact strength and tie performance. FIG. 2 shows an composite 10 that is comprised of a thermoplastic material of the present invention 20. It has much smaller and much more evenly dispersed shrinkage voids 13. FIG. 3 shows a composite of the present invention 30 that has a core 40 comprises of a first thermoplastic material, and bonded to the core, a sheath 20 comprised of a second thermoplastic material. Again, pursuant to the present invention, the shrinkage voids 13 are smaller and relatively evenly dispersed. FIG. 4 shows a cross section of a marine piling of the present invention. This example has the same components as those listed in FIG. 4, further including the central longitudinal axis 42 and outer or peripheral surface of the core 43.

In other embodiments of the present invention, the composites may have various uses such as various types of pilings (e.g., marine pilings), architectural columns, bridge timber, mine support timber, highway guardrails, highway guardrail posts, utility poles, road curbs.

Furthermore, the composites may be used as dimensional lumber. Examples include deck lumber, fence lumber, deck posts, landscaping timbers, and fence posts. Measurements of these examples typically range from about 1 to 6 inches in thickness and about 3 to 12 inches in width. Overall, the lengths and weights and uses of the composites can vary widely. For example, the composites of the present invention include those ranging from about 3 feet to over about 60 or 80 feet.

Additionally, the composites may be used as house or building siding and trim members, framing lumbers (specifically including studs, joists, rafters, sub-flooring, etc.).

The composites of the present invention may be made by direct compound extrusion, co-extrusion, cross head extrusion, sequential extrusion, or extrusion molding, conventional molding, flow molding as is known in the art. In all cases, the use of a co-rotating compounding extruder is preferred, such as a Berstorff ZE75A or similar co-rotating compounding extruder.

Preferably, when the composites incorporate the sheath/core described herein, they are made with a one-step extrusion, or direct compound extrusion, or a sequential extrusion process. This process includes the steps of extruding a polymeric melt material through a die to form a composite of the present invention. This process does not require a pelletization step. These composites may be made by supplying a first thermoplastic polymer melt to a first extruder, and continuously feeding the first thermoplastic polymer melt through the first extruder to form a thermoplastic core. The thermoplastic core is then cooled to below the melting point of the thermoplastic core. A second thermoplastic polymer melt is supplied to a second extruder, the second extruder being a crosshead die extruder. The cooling step is followed by the step of continuously feeding the second thermoplastic polymer through a second extruder to form a thermoplastic sheath, with the feeding step applying the second polymer melt around the core to form a thermoplastic sheath in a sheath/core arrangement. Finally, the sheath is cooled to below the melting point of the thermoplastic sheath.

In embodiments of the present invention, railroad cross ties are made ranging from about 7 inches thick and 9 inches wide, and have an internal core that is about 3.5 inches thick and 3.5 inches wide. Since this preferred embodiment is a continuous extrusion process the crosstie can be cut to the desired length as it is removed from the cooling phase of the extrusion line. In the molding process, products are molded to length. Thin products such as decking lumber composites of the present invention are typically about 1 to 2 inches thick and about 4 to 6 inches wide. A core element may not necessarily be present in these embodiments.

The composites of the present invention can also be made pursuant to U.S. Pat. Nos. 5,799,870, 5,650,224, and U.S. patent application Publication No. 2003/0227108 to Okerson, all three of which are incorporated herein by reference. However, the compositions of the present invention are advantageous to those in '244 in that rebar is no required to provide sufficient strength to the composites of the present invention. Thus, the rebar aspects of '244 do not apply herein.

In order to fully illustrate the present invention, the following examples are given, it being understood that same are intended as illustrative and in no way limiting.

### EXAMPLE 1

A thermoplastic composition for use in forming a composite of the present invention is prepared as follows:

a blend of reclaimed high density polyethylene and polypropylene is combined with Vertal UA40 talc in a ratio (by weight) of about 60% thermoplastic resin and about 40% Vertal UA40.

### EXAMPLE 2

A thermoplastic composition for use in forming a composite of the present invention is prepared as follows:

a blend of reclaimed high density polyethylene and low density polyethylene is combined with Vertal UA40 talc and a calcium sulfate filler in a ratio (by weight) of about 60% thermoplastic resin and about 20% Vertal UA40 and about 20% calcium sulfate.

The invention being described in the Specification and Drawings, it will be apparent to those skilled in the art that various modifications and variations can be made in the present invention without departing from the scope or spirit of the invention. All such modifications and variations as would be obvious are within the scope of the invention. It is intended that the Examples and Figures be considered as exemplary only, and not intended to limit the scope and spirit of the invention.

Unless otherwise indicated, all amounts are construed as being modified by the word “about.” “About” specifically covers nominal measurements. For example, for a nominal 6-inch post, the actual measurements may be at least 5% more or less than 6 inches. Unless stated otherwise, all ranges included herein that include an upper end and a lower range cover all points herein in between, Additionally, throughout this disclosure various patents and other publications are referenced. Finally, unless otherwise the amounts stated herein are weight percent.

All patents and publications referenced herein are incorporated herein by reference in their entirety.

I claim:

1. A large, elongated polymeric composite, comprising:
a central longitudinal axis; and consisting essentially of about 35% to about 65% by weight of a thermoplastic resin, about 25% to about 45% by weight of talc, and a filler;
the composite being substantially free of voids and at least about 3 feet in length and at least about 0.5 inches in diameter from the central longitudinal axis to an outer surface of the sheath.

2. The large, elongated composite of claim 1, wherein the composite comprises
a solid core that has a peripheral surface and extends a length of the axis and consisting essentially of about 35% to about 65% by weight of a thermoplastic resin, about 25% to about 45% by weight of talc, and a filler; and
a solid sheath that surrounds and bonds with a length of the peripheral surface of the core and consisting essentially of about 35% to about 65% by weight of a thermoplastic resin, about 25% to about 45% by weight of talc, and a filler.

3. The large, elongated polymeric composite of claim 1, wherein the core material independent of, and may be the same or different from, the sheath material.

4. The large, elongated polymeric composite of claim 1, wherein at least one of the thermoplastic resins comprise a polyolefin material selected from the group consisting of low-density polyethylene, high-density polyethylene, linear polyethylene, polypropylene, and blends thereof.

5. The large, elongated polymeric composite of claim 1, wherein at least one of the thermoplastic resin is reclaimed.

6. The large, elongated polymeric composite of claim 1, consisting essentially of:
a reclaimed thermoplastic resin of a formulation, in weight/weight amounts, selected from (i) about 65% by weight thermoplastic resin and about 20-30% by weight talc blend, (ii) about 60% by weight thermoplastic resin and about 25-35% by weight talc blend, (iii) about 55% by weight thermoplastic resin and about 30-40% by weight talc blend, (iv) about 50% by weight thermoplastic resin and about 45-55% by weight talc blend, (v) about 45% by weight thermoplastic resin and about 40-50% by weight talc blend, or (vi) about 40% by weight thermoplastic resin and about 45-55% by weight talc blend.

7. The large, elongated polymeric composite of claim 1, wherein the talc is of the formula Mg₃Si₄O₁₀(OH)₂.

8. The large, elongated polymeric composite of claim 1, wherein the talc comprises a filler material to form a talc blend, the filler being selected from the group consisting of calcium carbonate, mica, marble dust, graphite, aluminum flake, diatomaceous earth, cement dust, clay, feldspar, silica, glass, fumed silica, silicates, alumina, magnesium oxide, antimony oxide, zinc oxide, barium sulfate, aluminum silicate, calcium silicate, titanium oxides, glass micro spheres, wollastonite, nephelene syenite, calcium sulfate, gypsum, chalk, carbon black, and blends thereof.

9. The large, elongated polymeric composite of claim 8, wherein filler content is about 15% by weight to about 40% by weight of the talc and filler combination.

10. The large, elongated polymeric composite of claim 1, wherein the talc has a particle size of about 0.3 μm to about 10 μm.

11. The large, elongated polymeric composite of claim 1, wherein shrinkage voids are present in the composite in an amount of less than about 5%.

12. The large, elongated polymeric composite of claim 1, wherein the thermoplastic resin composition includes a flame retardant.

13. The large, elongated polymeric composite of claim 1, wherein the thermoplastic resin composition includes a compatibilizer.

14. The large, elongated polymeric composite of claim 1, wherein the thermoplastic resin composition includes a pigment, dye, antioxidant, ultraviolet light stabilizer, slip agents, nucleating agent, anti-fungal agent, mold release, and combinations thereof.

15. The large, elongated polymeric composite of claim 1, wherein the composite is a marine piling, mine timber, architectural column, bridge timber, utility pole, highway guardrail post, road curb.

16. The large, elongated polymeric composite of claim 1, wherein the composite is dimensional lumber.

17. The large, elongated polymeric composite of claim 1, wherein the composite is a railroad tie.

18. The composite of claim 17, wherein the tie has a length of from about 6 to about 25 feet, a width of about 8 inches to about 12 inches, and a height of from about 5 inches to about 10 inches.

19. The composite of claim 17, wherein the tie has a weight of about 200 to about 900 pounds.

20. The large, elongated polymeric composite of claim 1, wherein shrinkage voids are present in the composite in an amount of less than about 3%.

21. The large, elongated polymeric composite of claim 1, wherein shrinkage voids are present in the composite in an amount of less than about 1%.

22. A thermoplastic composite, comprising:
(a) about 35% to about 65% of a thermoplastic resin selected from the group consisting of low-density polyethylene, high-density polyethylene, linear polyethylene, polypropylene, and blends thereof and (b) about 40% to about 60% by weight of a talc blend;
the core and sheath being substantially free from shrinkage voids; and
the core and sheath forming an elongated composite at least about 3 feet in length.

23. The thermoplastic composite, of claim 22 that includes a:
a core element that comprises (a) about 35% to about 65% of a thermoplastic resin selected from the group consisting of low-density polyethylene, high-density polyethylene, linear polyethylene, polypropylene, and blends thereof and (b) about 40% to about 60% by weight of a talc blend;
a sheath element that is bonded to the core element and independently of the core comprises (a) about 35% to about 65% of a thermoplastic resin selected from the group consisting of low-density polyethylene, high-density polyethylene, linear polyethylene, polypropylene, and blends thereof and (b) about 40% to about 60% by weight of a talc blend.

24. The thermoplastic composite of claim 22, comprising less than about 5% shrinkage voids.

25. The thermoplastic composite of claim 22, comprising less than about 3% shrinkage voids.

26. The thermoplastic composite of claim 22, comprising less than about 1% shrinkage voids.

27. The thermoplastic composite of claim 22, wherein the talc blend has a particle size of about 0.3 μm to about 10 μm.

28. The thermoplastic composite of claim 22, wherein the thermoplastic composite includes a pigment, dye, antioxidant, ultraviolet light stabilizer, slip agents, nucleating agent, anti-fungal agent, mold release, and combinations thereof.

29. The thermoplastic composite of claim 22, wherein the composite is a railroad tie.

30. The thermoplastic composite of claim 28, wherein the tie has a length of from about 6 to about 10 feet, a width of about 8 inches to about 12 inches, and a height of from about 5 inches to about 10 inches.

31. The thermoplastic composite of claim 22, wherein the length of the composite is any distance between about 6 feet and 80 feet.

32. The thermoplastic composite of claim 22, wherein the thermoplastic resin comprises reclaimed thermoplastic material.

33. A thermoplastic composition, consisting essentially of:
a reclaimed thermoplastic resin in an amount of from about 35% to about 65% by weight of the composition, selected from the group consisting of low-density polyethylene, high-density polyethylene, linear polyethylene, polypropylene, and blends thereof;
talc particles in at least about 25% to about 40% by weight of the composition; and
additives in an amount of from about 15% to about 40% by weight of the composition selected from the group consisting of calcium carbonate, mica, marble dust, graphite, aluminum flake, diatomaceous earth, cement dust, clay, feldspar, silica, glass, fumed silica, silicates, alumina, magnesium oxide, antimony oxide, zinc oxide, barium sulfate, aluminum silicate, calcium silicate, titanium oxides, glass micro spheres, wollastonite, nephelene syenite, calcium sulfate, gypsum, chalk, carbon black, and blends thereof. In embodiments of the present invention where a talc blend is used, the filler (mineral filler) content is about 15% by weight to about 40% by weight. In other embodiments, the total filler is present in a range of from about 40% to about 60%. The talc blend content may range from about 30%-40% (by weight), and in other embodiments about 40%-60% (by weight).
